(19) United States
(12) Patent Application Publication
(10) Pub. No.: US 2006/0200377 A1
(43) Pub. Date: Sep. 7, 2006

(54) Affiliate network cross-publication system and method

(76) Inventors: Jason S. Wolfe, Pittsburgh, PA (US); Gregory Stoltz, Pittsburgh, PA (US); Mark J. Romanelli, Bridgeville, PA (US); Mark W. Yost, Pittsburgh, PA (US); Jason M. Hewes, Pittsburgh, PA (US)

Correspondence Address: NORTH OAKS PATENT AGENCY, 45 ISLAND ROAD, NORTH OAKS, MN, 55127, US

(21) Appl. No.: 11/354,350

(22) Filed: Feb. 14, 2006

Related U.S. Application Data
(60) Provisional application No. 60/652,779, filed on Feb. 14, 2005.

(51) Int. Cl. G07G 1/00; G06F 17/30

(52) U.S. Cl. 705/10

(57) ABSTRACT

A cross publication tool and its method of use is described. The tool allows affiliate network system clients to easily publish offers to one another. Copying a cross published offer from one client to another occurs automatically upon the approval of the publishing client. Lead and sale tracking is also automated to ensure that there are no tracking discrepancies.

### RELATED APPLICATIONS

This application claims the benefit of U.S. Provisional Application No. 60/652,779, filed 14 Feb. 2005, entitled “Network Cross Publication”.

### FIELD OF THE INVENTION

The present invention relates to marketing campaign systems for use on the Internet. More particularly, the present invention relates to a system and method for affiliate network cross publication of marketing campaigns.

### BACKGROUND OF THE INVENTION

Through the use of a common software structure, a network of computers known as the world-wide web or Internet, enables vast and immediate interconnectedness for many users. This common software structure is known as hypertext markup language or “HTML” that is generated and read via browser computer software code. Access to information and movement around the Internet is enhanced through the use of hyperlinks (“links”) within a web page's HTML. The link, which is typically a word in a text field or an image on a web page, acts as a path, that moves a user from one web page address, known as a Uniform Resource Locator (URL), to another web page address. The movement from one URL to another allows near-instant access to information, products, and services and is particularly well-suited to the exchange of information, goods, and services between buyers (“Users”) and sellers (“Sellers”). Such business is commonly referred to as “e-commerce,” or “electronic commerce.”

With the abundance of goods and services available, a problem arises in efficiently connecting an interested user with the appropriate information pertaining to the desired goods and/or services. A Seller therefore must make known, or advertise, its URL in order to reach those users on the Internet that are interested in the goods and/or services offered. HTML links lend themselves to an active (rather than static) advertisement since they actually provide the user with a path or entry point to the Seller's URL. Then, once at the Seller's URL, the user can initiate a transaction.

By advertising through the use of hyperlinked banner images and/or text links, a Seller may increase its sales by increasing the number of users (commonly referred to as “traffic”) that visit their URL, and potentially increase their transactions. The Seller must determine how and where on the Internet to advertise in order to maximize traffic that fits the Seller's targeted market. In contrast to traditional static advertising, hyperlinked active advertising provides the opportunity to chart a transaction from inception to end, beginning with the initial movement from advertisement to Seller URL, and ending with the user's completed transaction.

A typical tracking mechanism allows the Seller to see where its traffic is coming from (i.e., from a given advertisement at a given URL). Further, the tracking mechanism allows the Seller to determine advertising compensation based on quantity of traffic and/or the traffic's performance. Such a system, which relies on a tracking mechanism, is commonly referred to as an affiliate system.

Sellers currently utilize some form of affiliate system to increase sales, track traffic, and compensate Webmasters for referrals of traffic and/or transactions. Webmasters are the content providers of the Internet, who maintain URLs in order to disperse information and links to other URLs. These links are often in the form of a Seller's advertisement, such as a banner ad. Therefore, the Webmaster directs traffic to given Sellers via their selection and placement of Seller links. The Webmasters are then generally compensated according to a given scale or interval, based in some way on the referred traffic.

Several affiliate system resources exist that address various aspects of affiliate commerce, including: search engines, directories, and compilations of Webmaster feedback relating exclusively to affiliate systems.

Two distinct models of affiliate systems have developed. The first is a stand-alone affiliate system for a single Seller. The second type is an affiliate hub system that encompasses multiple Sellers within one master affiliate system.

In a stand-alone affiliate system, a group of Webmasters are linked together with a Seller affiliate system. The Seller's affiliate system is a full framework that operates the Seller's affiliate program. Generally, the Seller's affiliate system includes the Seller's back-end tracking mechanism, which keeps track of transactions and credits affiliates, the accounting system for payout of affiliates, the reporting system for reporting transaction statistics back to affiliates, and the support system for affiliate and technical support.

In use, the group of Webmasters send traffic through the surrounding affiliate system. The traffic is tracked and any transactions initiated by the traffic are credited to the referring Webmaster. Each Webmaster has access to the full framework of affiliate services offered by the Seller's affiliate system. The stand-alone affiliate system is utilized only by one Seller and that Seller's network of affiliated Webmasters. As would be expected, the Seller retains full access to and control of its affiliate system, as well as full responsibility for promotion, administration, and improvement of the system. A good example of a stand-alone affiliate system is that used by AMAZON.COM.

A number of shortcomings become evident in regard to the stand-alone affiliate system. First, from the Seller's point of view, there is a large startup cost, since the Seller needs to have its entire affiliate system in place before even one Webmaster can begin to refer transactions. Second, the stand-alone affiliate system suffers from slow growth, mainly due to a switch in target market, such as a switch from obtaining new consumers (Users) to new Webmasters. The single Seller may also fail to attract Webmasters simply due to the limited number of goods and/or services available for promotion. In addition, the stand-alone affiliate system entails a continuing burden of administration, promotion of the system, and Webmaster relations, all of which can tax the single Seller's resources.

In addition, there are several drawbacks to the stand-alone affiliate program from the Webmaster's point of view. Generally, the Webmaster can only represent the goods and/or services of a single Seller. Ideally, a Webmaster would offer a variety of goods and/or services to its traffic in order to generate increased revenue from the available customers. In order for a Webmaster using the stand-alone affiliate system to add a variety of Sellers to the Webmaster's web page, the Webmaster must find and join multiple stand-alone programs. This makes administration of the Webmaster's business more complex because the Webmaster must then coordinate with many programs—each with its own terms, conditions, accounting, tracking and customer service—in order to keep abreast of the performance of the Webmaster's referred traffic.

An affiliate hub system includes a group of Webmasters, a master affiliate system, and an affiliate network having individual affiliate systems. The master affiliate system processes Webmaster information and organizes the Webmasters into the networked affiliate programs. The group of Webmasters send traffic through the surrounding master affiliate system to the individual affiliate programs. Each individual affiliate system of the affiliate network uses the framework of the master affiliate system. This framework includes a back-end tracking mechanism (which keeps track of transactions and credits affiliates), an accounting system for payout of affiliates, a reporting system for reporting transaction statistics back to affiliates, and a support system for affiliate and technical support.

Thus, each individual Seller affiliate system depends on the master affiliate system to provide the framework for the Webmasters with traffic to become affiliates and promote the Seller's particular goods and/or services. Each networked Seller affiliate system uses the same group of Webmasters and their traffic from within the master affiliate system. An example of an affiliate hub system is that used by LINKSHARE.COM.

Using the affiliate hub system, Webmasters can be affiliated with, or send traffic through, one or more of the networked Seller affiliate systems. Webmaster can also be affiliated with, or send traffic through, the master affiliate system (for example, a Webmaster already in the Linkshare network can promote Linkshare and earn commissions per referred new Webmaster who joins Linkshare).

The affiliate hub addresses some of the weaknesses of the stand-alone system in bringing together groups of Sellers into one network. In addition to gaining the use of the framework of the master affiliate system, a Seller entering the affiliate hub network has immediate exposure to the Webmasters within the hub, easing the growing pains of starting an affiliate program. The Webmaster also benefits from this system, with simplified, coordinated access to the goods and/or services of all Seller affiliate programs in the hub. However, the Sellers must share the same resources for traffic (the group of Webmasters), and thus risk losing business to other Sellers in the hub.

The present invention provides a solution to these needs and other problems, and offers other advantages over the prior art.

### BRIEF SUMMARY OF THE INVENTION

The present invention is related to a software system that solves the above-mentioned problems. In accordance with one embodiment of the invention, a CrossPublication tool and its method of use is described. The tool allows affiliate network system clients to easily publish offers to one another. Copying a CrossPublished offer from one client to another occurs automatically upon the approval of the publishing client. Lead and Sale tracking is also automated to ensure that there are no tracking discrepancies.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 shows a diagram of cross publication between affiliate networks.

FIG. 2 is a flowchart showing a cross publication life cycle where a campaign is offered to another network in accordance with one embodiment of the present invention.

FIG. 3 is a flowchart showing a re-cross publication life cycle, which is similar to the cross publication life cycle shown in FIG. 2, where a previously cross published campaign is offered to another network by the child network to a grand child network.

FIGS. 4 through 77 depict a series of user interfaces for a preferred embodiment CrossPublication tool that allows clients to easily publish offers to other clients in the affiliate network.

### DETAILED DESCRIPTION

Throughout the following description are few terms which are utilized that may have a meaning beyond that understood by those skilled in the art. For the sake of clarity these terms are defined below.
CrossPublication as used herein means a tool used to facilitate the publication of an offer from one affiliate system client network to another. CrossPublication may also mean a campaign that has been made available from one affiliate system client network to another using the CrossPublication tool.
CrossPublish as used herein means the act of making your campaign available to another affiliate system client network by using the affiliate system CrossPublication tool.
Publish as used herein is a shortened form of CrossPublish.
Publisher as used herein means an affiliate system client who is making his campaign available through the affiliate system CrossPublication tool. Sometimes referred to as the “Parent” or “Parent Network” when used in reference to an offer that has been CrossPublished to another affiliate system client network.
Publishee as used herein means an affiliate system client who has signed up to receive CrossPublished offers through the affiliate system CrossPublication tool. Sometimes referred to as the “Child” or “Child Network” when used in reference to an offer that has been CrossPublished from another affiliate system client network.
Campaign as used herein means an offer or program in the affiliate system that has, at the minimum, one piece of creative and some payout information and that can be CrossPublished to other affiliate system client networks.
Creative is a piece of promotional material used to advertise some product (i.e. banner ads, commercial emails).
Network as used herein means an affiliate system client network who is capable of CrossPublishing and receiving CrossPublished campaigns. More generally a “Network” is the intermediary between a group of advertisers and affiliates.
Merchant as used herein means affiliate system clients who can only CrossPublish campaigns to all affiliate system Network clients.
Advertiser is any person or company who wishes to sell some product.
Affiliate is any person or company with the ability to drive traffic to the advertiser's website
End User is an individual whose interaction with creative is tracked by the affiliate network system on behalf of the network.
Action is performed by the end user whenever the end user does something on the advertiser's website. An Action can be a purchase of the goods or services that the advertiser is selling, providing some information to the advertiser, or it can be as simple as just clicking on a button on the advertiser's web page.
Parent as used herein means Network or Merchant offering campaign to other Networks.
Child as used herein means a Network accepting a campaign from the Parent.
ReCrossPublication as used herein means the ability of a Child to CrossPublish an offer that has been CrossPublished to them.
Grandchild as used herein means a Network accepting a campaign from a Child.

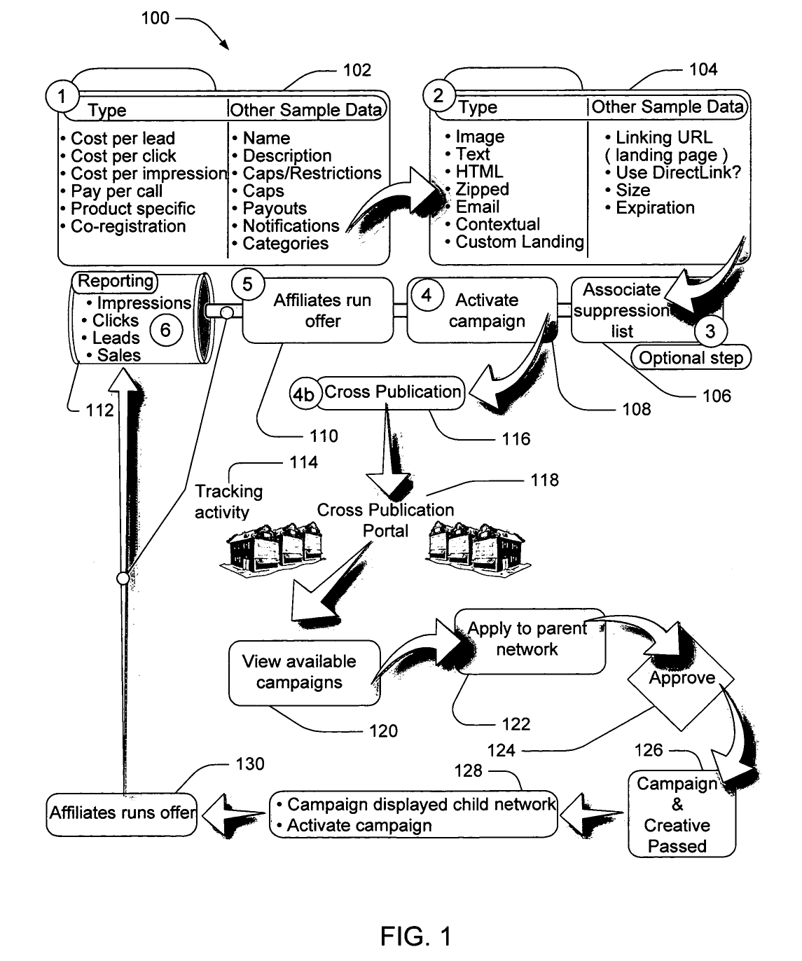

FIG. 1 shows cross publication between affiliate networks. Advertiser or Advertising Network (the Parent) creates 102 a campaign offer that they wish to have affiliates or publishers promote. The campaign Type refers to how the affiliate or publisher will be compensated. The Parent company must also associate 104 creative(s) with the campaign so the affiliates/publishers may promote the campaign online. If the Parent company allows the affiliates/publishers to promote the offer via email, a suppression list may be associated 106 with the campaign. Following the campaign creation, the Parent company will activate 108 their campaign at which point they can both promote it to their own affiliates/publishers 110 as well as CrossPublish 116 the offer to the CrossPublication network. Once CrossPublished through a portal 118 managed by the affiliate network system operator, various Advertising Networks (Child Networks) have the option view 120 and apply 122 for the campaign. This portal 118 may be configured to accept campaigns from other advertising or affiliate networks that may or may not be operated by the same affiliate network system operator. Once approved 124 by the Parent company, the campaign and creative details are automatically passed 126 into the Child Network whereby they can promote 128 it to their own affiliate/publisher base. Once the affiliates/publishers of the Child Network begin promoting 130 the CrossPublished offer(s), tracking 114 begins to occur in both the Parent and Child Network. Tracking and reporting data 112 may consist of impressions, clicks, leads, sales or any combination of each.

To describe how CrossPublication works, it is important to understand from a high level how pixel tracking works. For the most general type of tracking, a network provides pieces of creative to their affiliates used to drive traffic to the network's advertiser's websites. Whenever the end user clicks on a piece of creative, the end user is taken to a script that places a cookie on the end user's computer, logs a click in the Network, and then redirects the end user to the advertiser's web page. The cookie placed on the end user's computer contains a code that allows the affiliate network system to associate an end user with the affiliate whose piece of creative the end user clicked on. Whenever an end user performs an action, code on the advertiser's website calls a script that reads the cookie placed on the end user's computer. This tracking script uses the cookie to assign the action to the affiliate who owned the banner that the end user originally clicked on. This click tracking process can be visualized as such:
End User Clicks on Creative ->the affiliate network system tracks click in the network ->End User goes to Advertiser's Website
The action tracking process can be visualized as such:
Perform an Action->View Page containing call to tracking script->the affiliate network system assigns action to affiliate

Whenever Network “A” (the Parent) CrossPublishes to Network “B” (the Child), a copy of the entire campaign (including all creatives) from the parent is copied to the child. If the child is not yet an affiliate of the parent, an affiliate account is created in the parent for the child. Thus, the child network as a whole is now an affiliate of the parent network. Affiliates of the child network can now run the campaign that was CrossPublished from the parent to the child. Affiliates of the child network are unaware that the campaign originally came from the parent network, thus preventing them from dealing directly with the parent network.

Whenever an end user clicks on a piece of creative from the child, the end user is taken to a tracking script for the child which places a cookie on the end user's computer, tracks a click in the child network, and then redirects the end user to the tracking script for the parent network. The cookie placed on the end user's computer from the child network contains a code that associates the end user with the affiliate whose piece of creative the end user clicked on. When the end user is redirected to the tracking script in the parent network, special code is added to link the two clicks together. The parent network's tracking script places a second cookie on the end user's computer, tracks a click in the parent network, and then redirects the end user to the advertiser's web page. The second cookie placed on the end user's computer from the parent network associates the end user with the child network's affiliate account in the parent network.
The CrossPublished click tracking process can be visualized as such:
End User Clicks on Creative->the affiliate network system tracks click in
Child Network->the affiliate network system tracks click in Parent
Network->End User goes to Advertiser's Website

Whenever an end user performs an action, the action is tracked in the parent network using the second cookie placed in the previous paragraph for the child's affiliate account. Later, the affiliate network system goes through all of the actions tracked for the child network's affiliate account in the parent, and then copies the actions to the affiliates of the children. The affiliate network system determines which affiliate to assign this action to by looking at the special code added to the link when the end user was redirected from the child's tracking script to the parent's tracking script.

The CrossPublication Action tracking process can be visualized as such:
Perform an Action->View Page containing call to tracking script from the parent network->the affiliate network system assigns action to affiliate (child network)

Later, . . .
the affiliate network system gets all actions of the child->the affiliate network system determines which actions belong to which affiliates of the child->the affiliate network system copies those actions to the child's affiliates

Pixel tracking is only one of several tracking methods that could be used to track in CrossPublication. Another form of tracking could be used where the end user is redirected directly from the child network's tracking script to the advertiser's page which contains javascript to track the click in the parent. Simple Object Access Protocol (SOAP) or other types of application programming interface (API) calls could be made to pass the click tracking information directly from the child to the parent. Actions could be tracked for the child network by displaying their action tracking pixel whenever the parent's action tracking pixel is displayed.

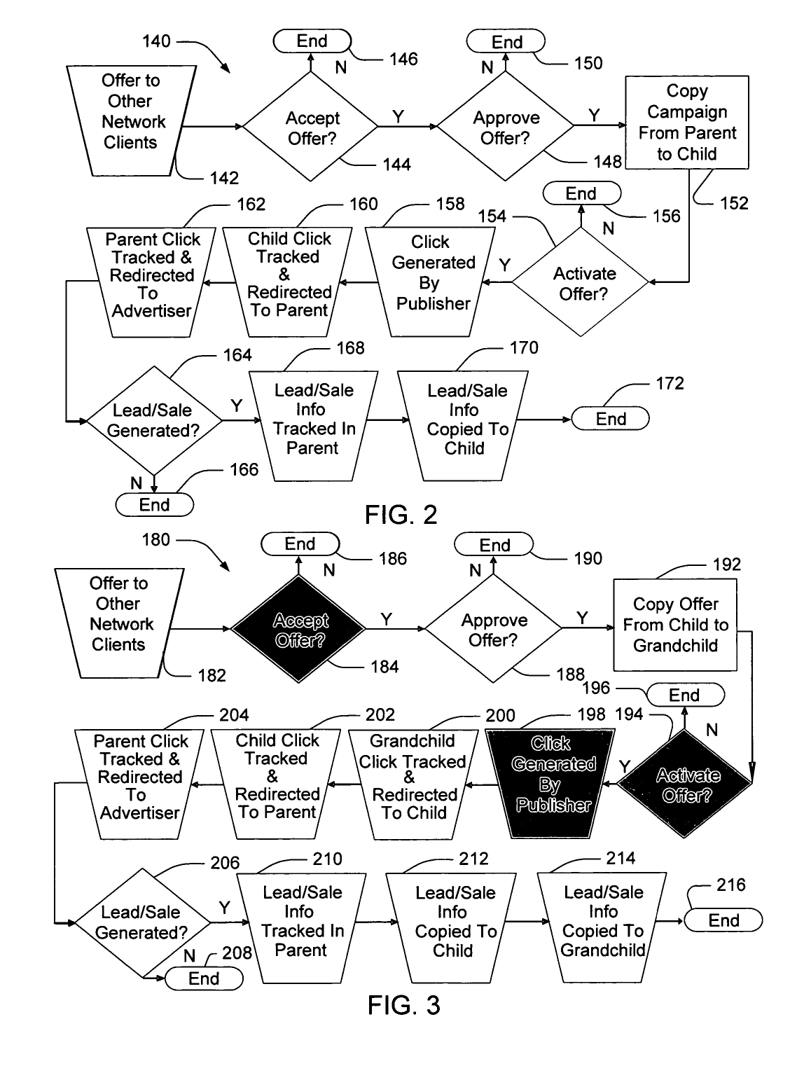

Referring now to FIG. 2, a CrossPublication life cycle 140 is shown. A Campaign is offered 142 to another network and this client will be the Parent. Campaigns can be offered out to all networks or specific networks. Another network is given a choice 144 to run the campaign. If they choose not to run the campaign the process ends 146. If they choose to run the offer, the process continues and they will be known as the Child. Subsequently, the Parent Network is given a choice 148 to approve the Child to run the campaign. If the Parent Network chooses to deny the Child the process ends 150. If the Parent network chooses to approve the Child to run the campaign the process continues. The network affiliate system copies 152 the appropriate information from the Parent to the Child. The Child is then given a choice 154 to activate the offer. If the Child chooses not to run the campaign the process ends 156. If the Child chooses to run the campaign the process continues. A click is generated 158 by the Child's Publisher. The affiliate network system tracks the Publisher's click 160 in the Child and redirects the user to the Parent. In addition, the affiliate network system tracks the Child's click in the Parent 162 and redirects the user to the Advertiser's site. The user completes the action to generate a lead/sale 164. If the action is not completed, the process ends 166. If the action is completed and the pixel is displayed, the lead/sale is tracked 168 in the Parent Network for the Child Network's account. Preferably, the Child's publisher information is stored in the optional information of the lead/sale details. The lead/sale information is copied 170 from the Parent to the Child. In addition, the optional information is read from the lead/sale to credit the appropriate publisher in the Child. The CrossPublication cycle 140 is complete 172.

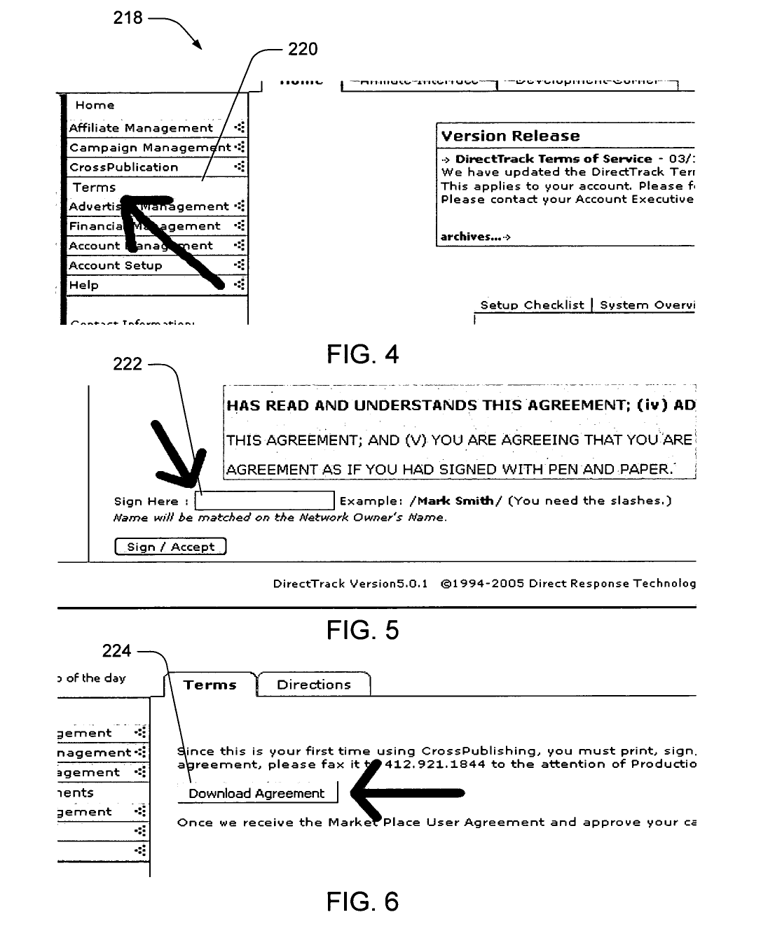

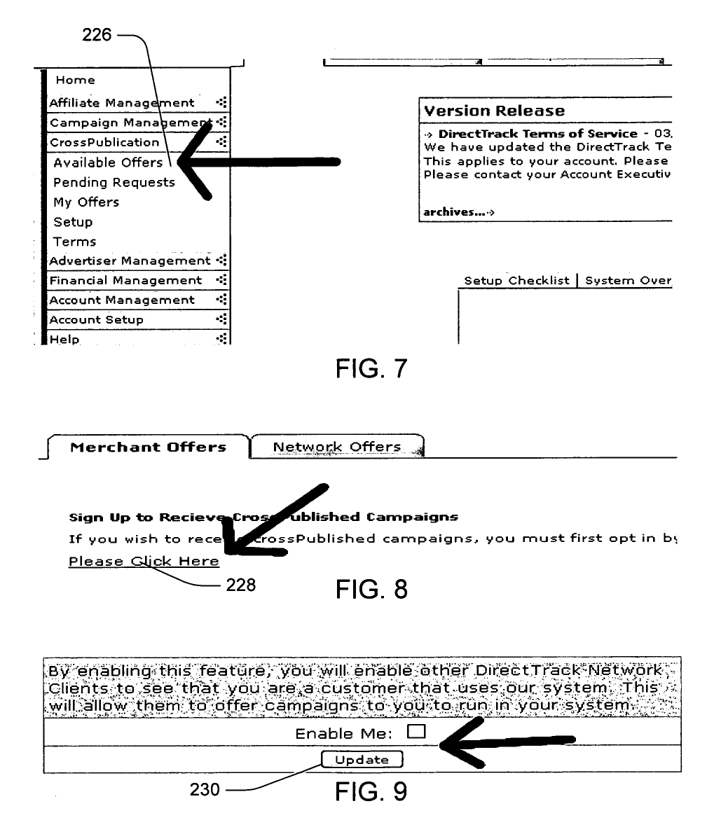

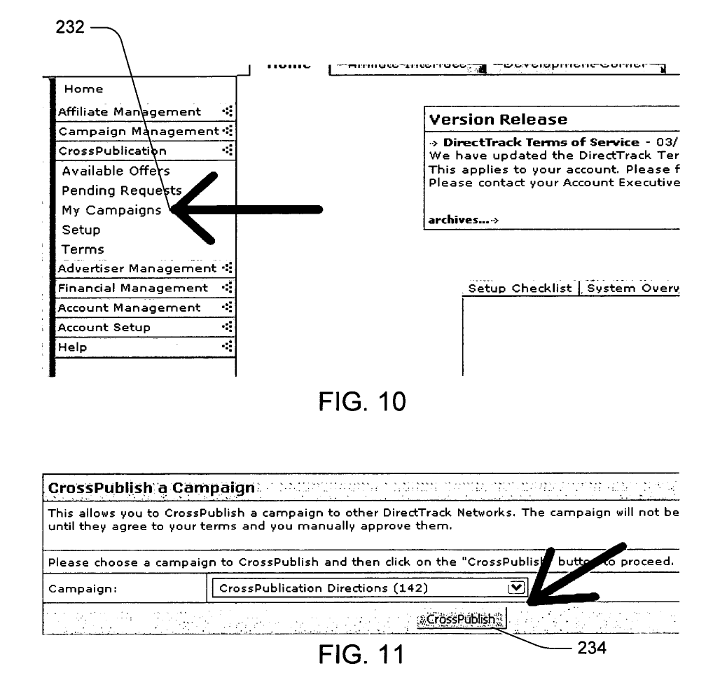

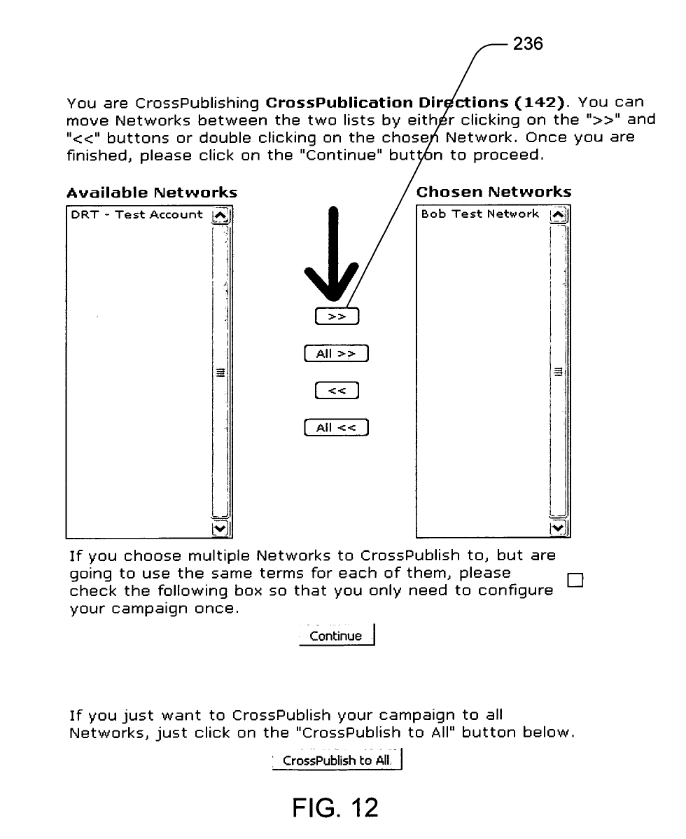

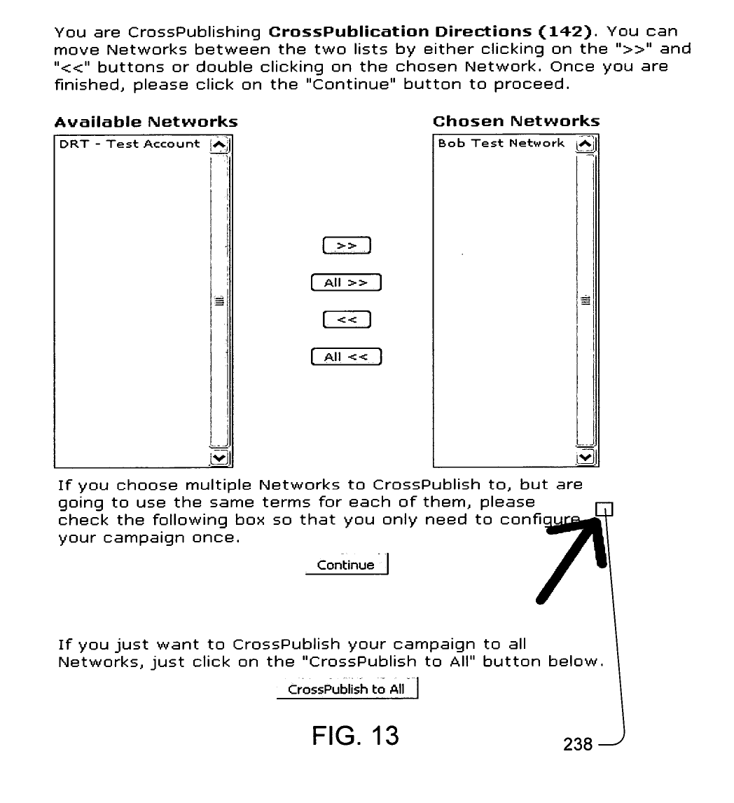

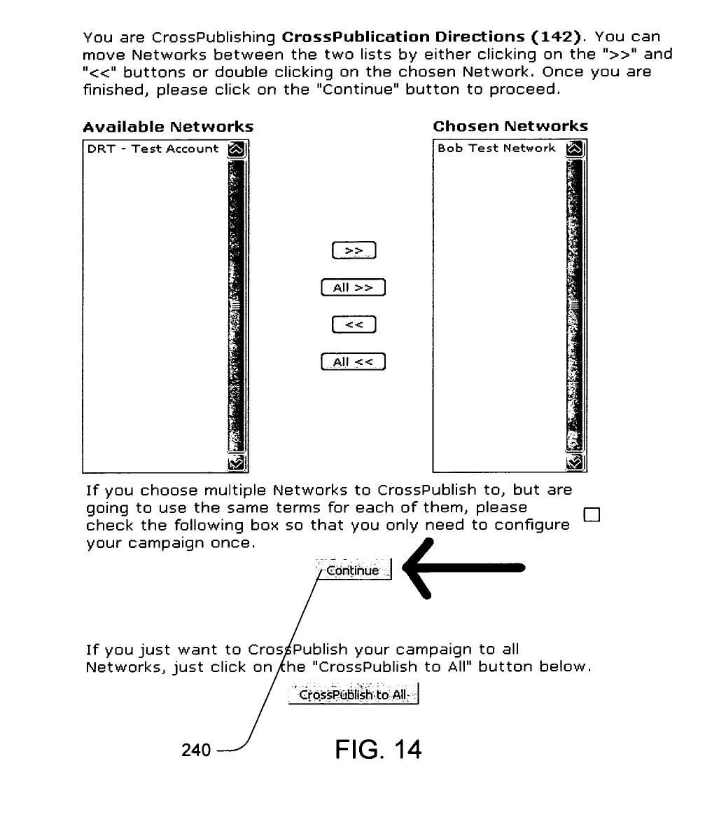

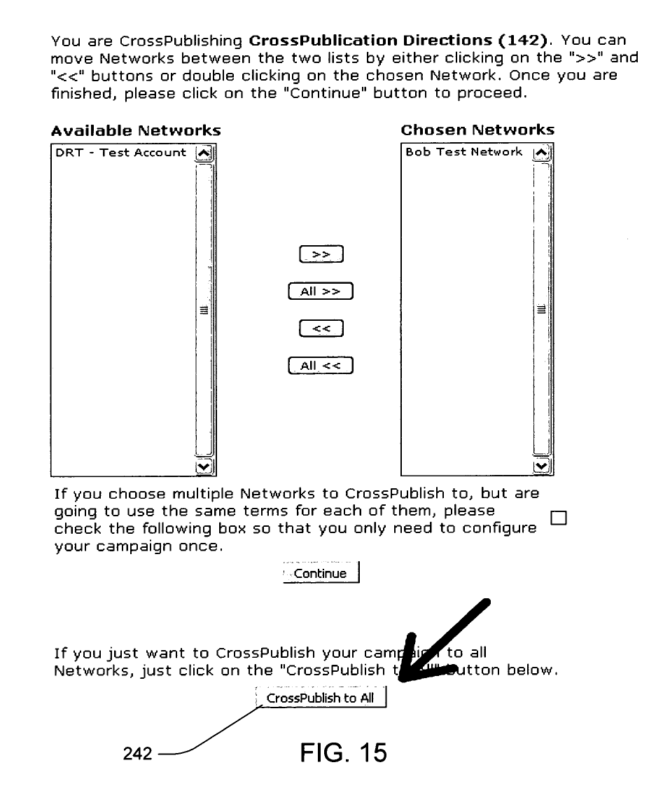

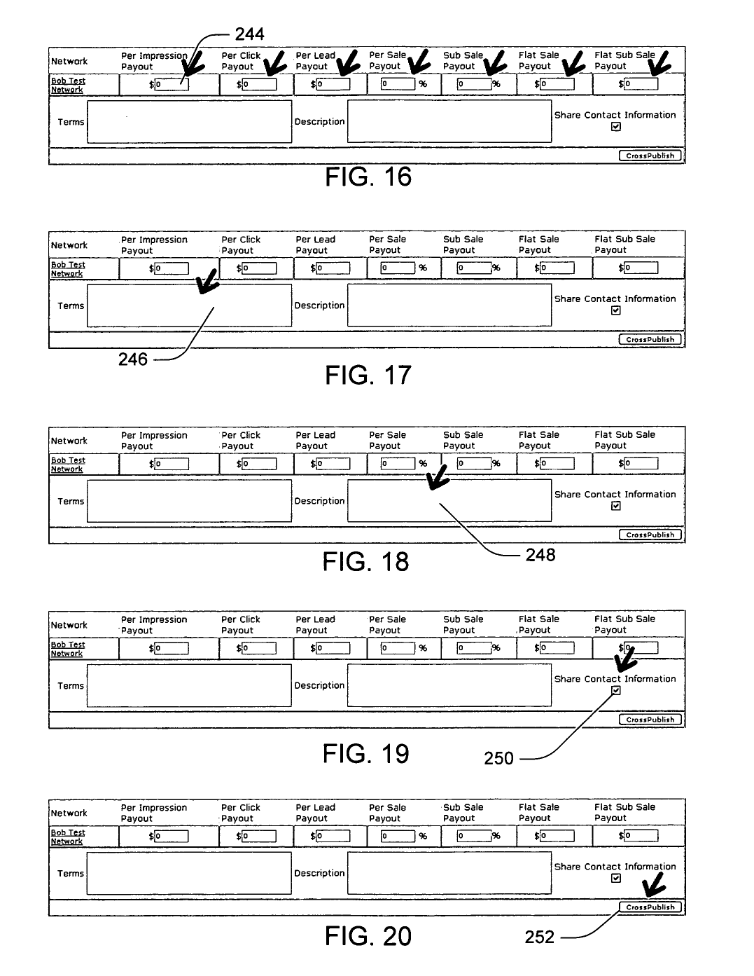

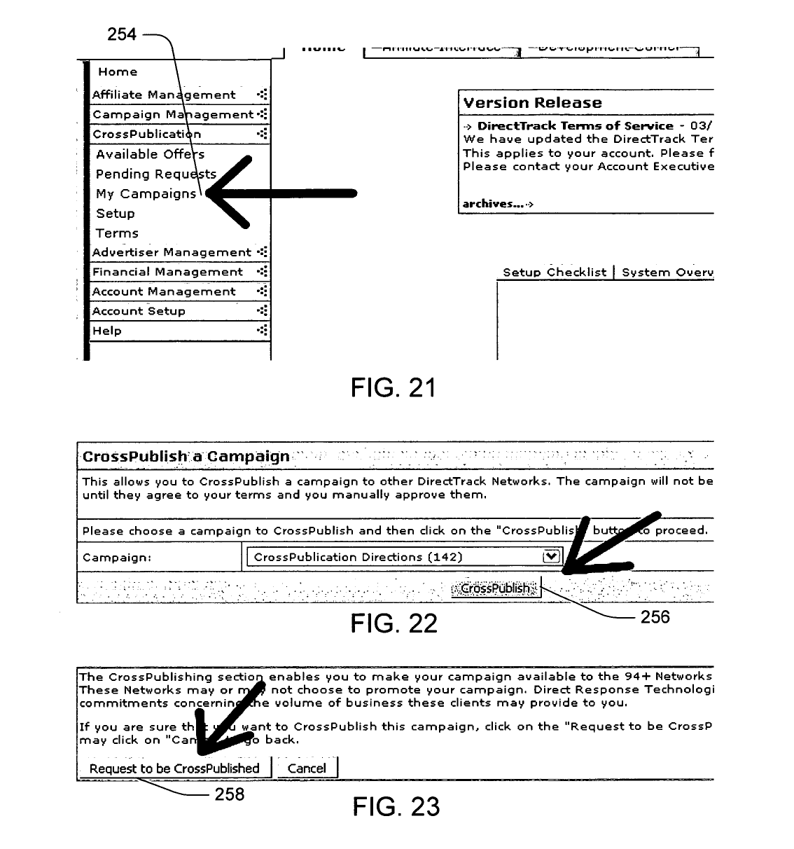

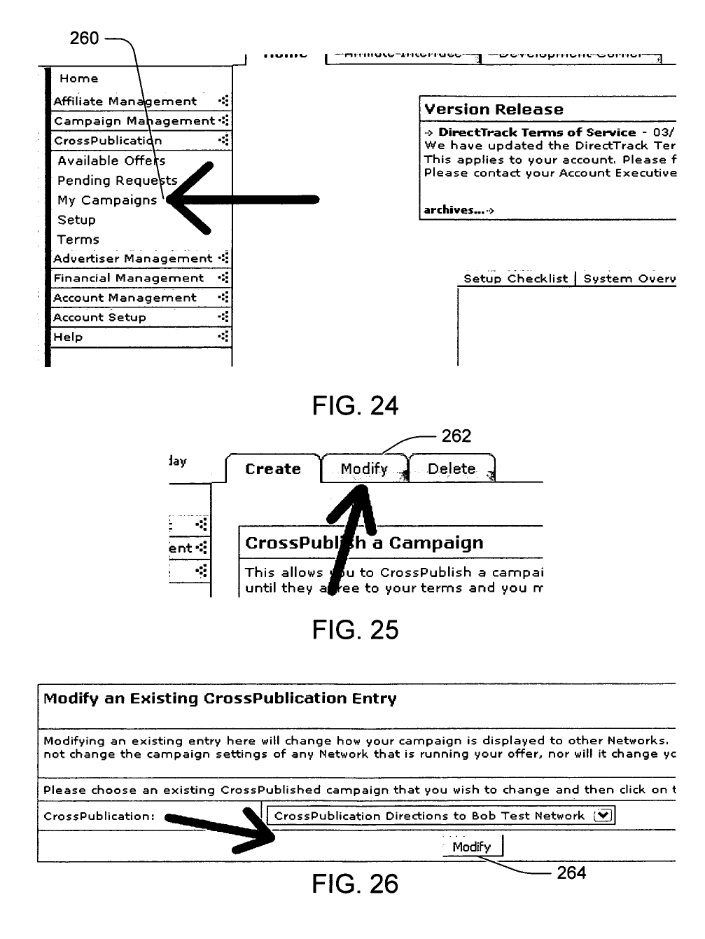

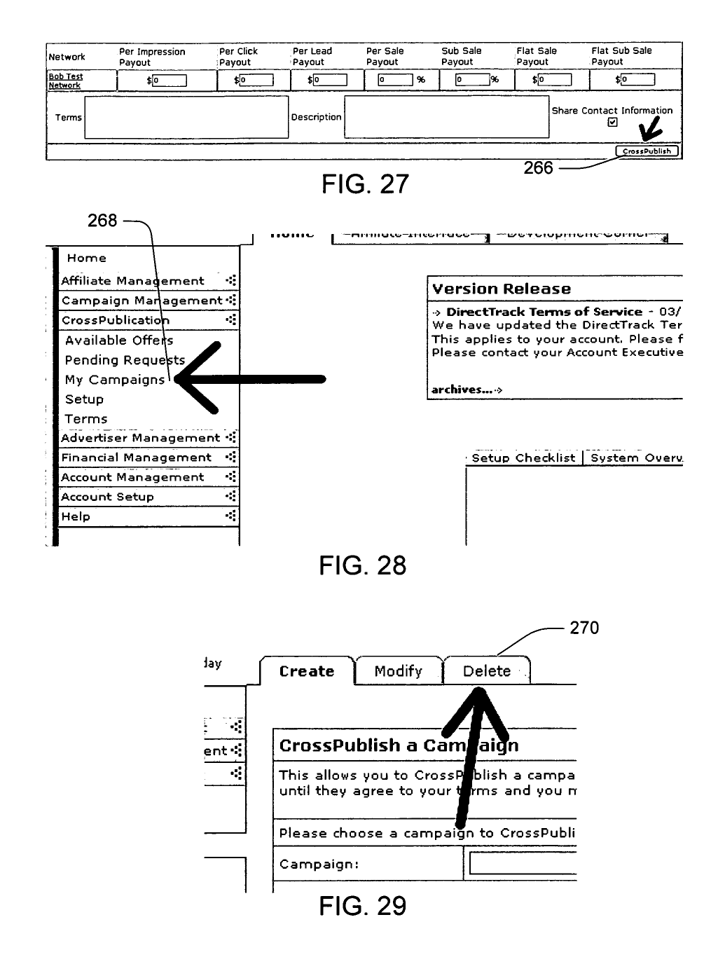

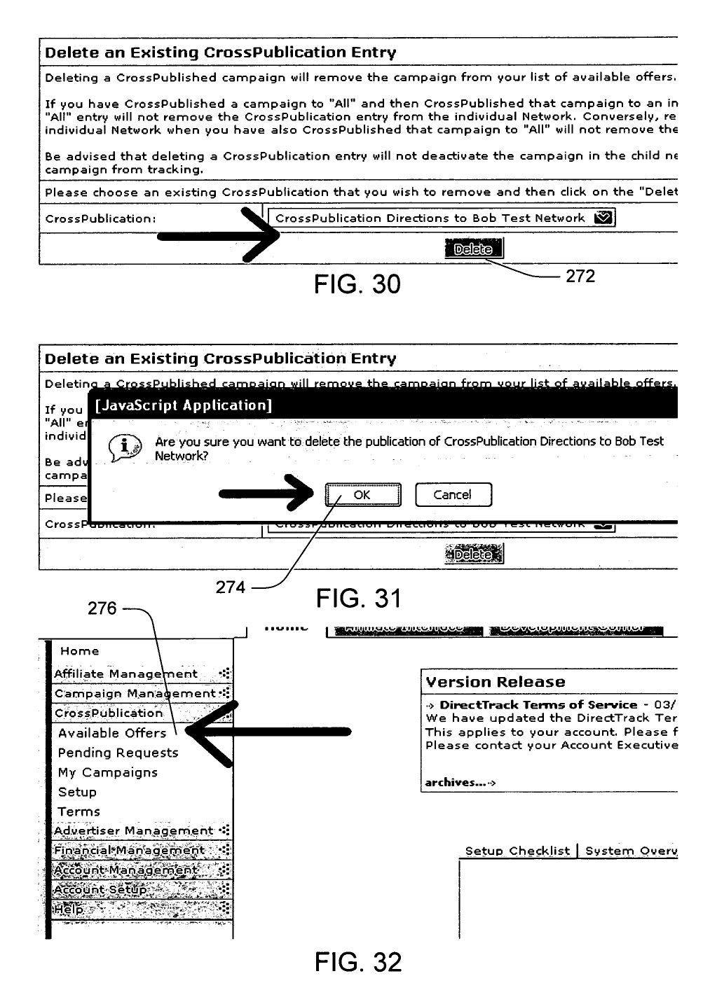

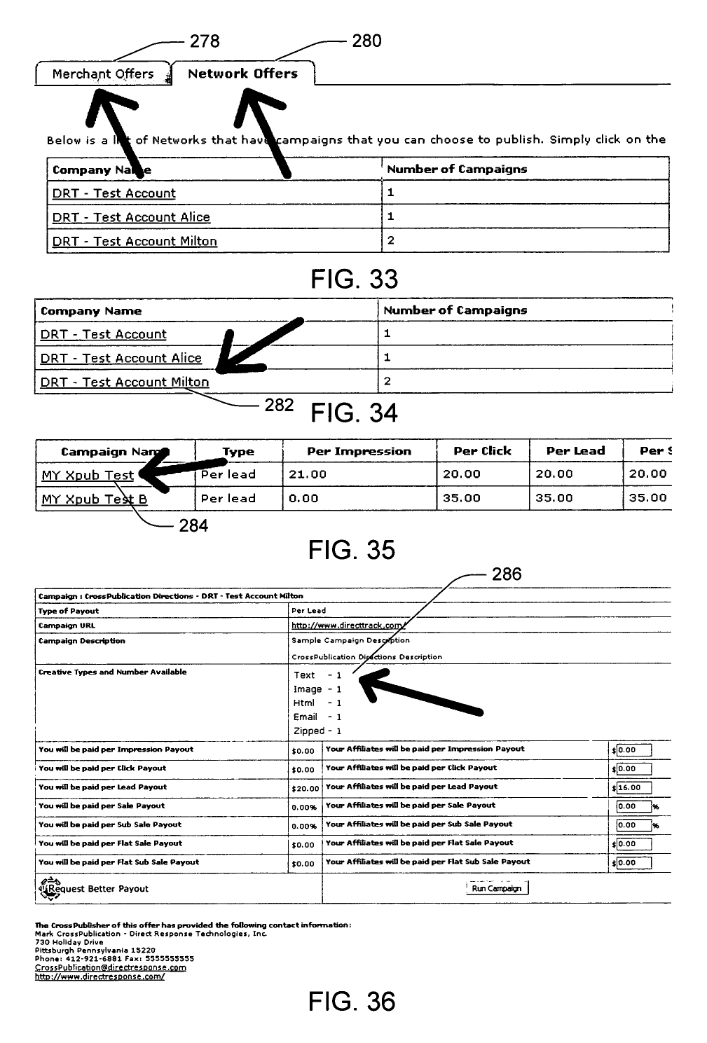

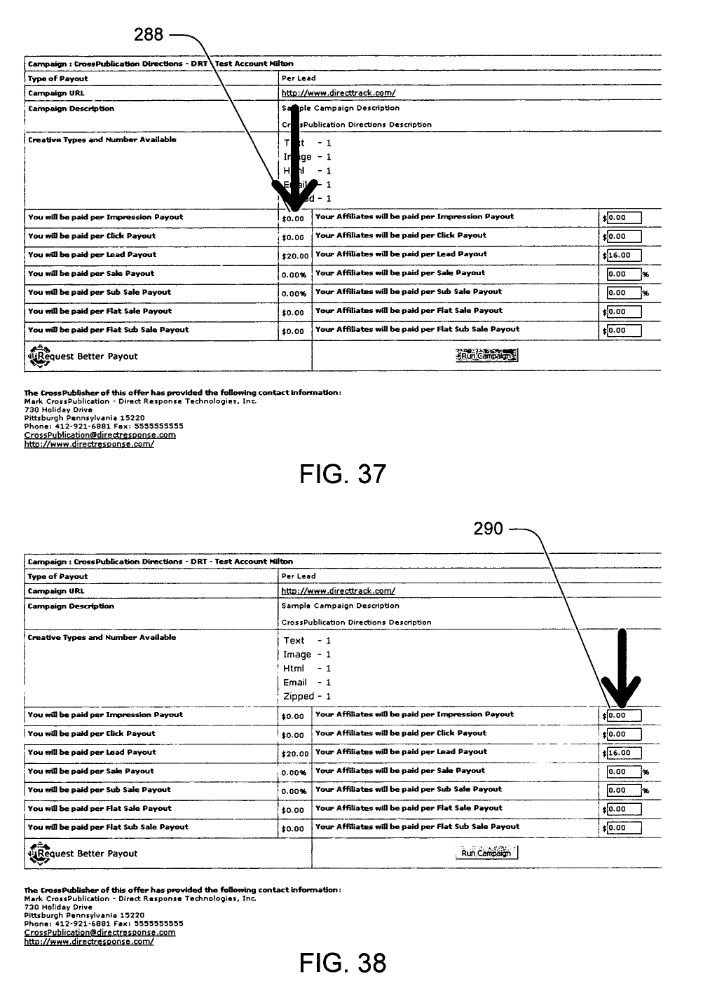

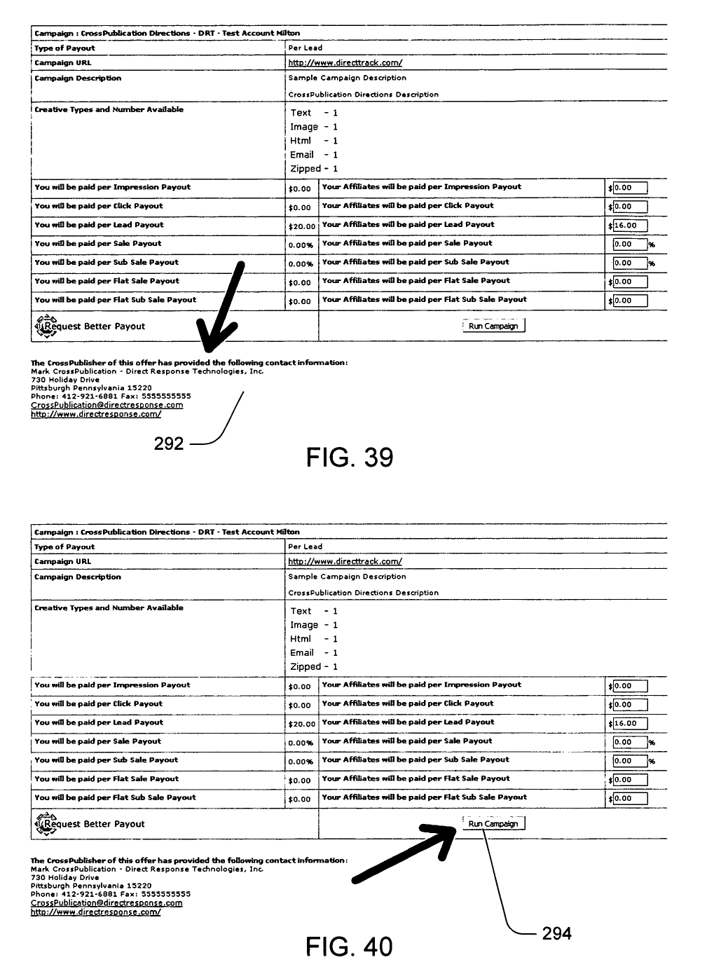

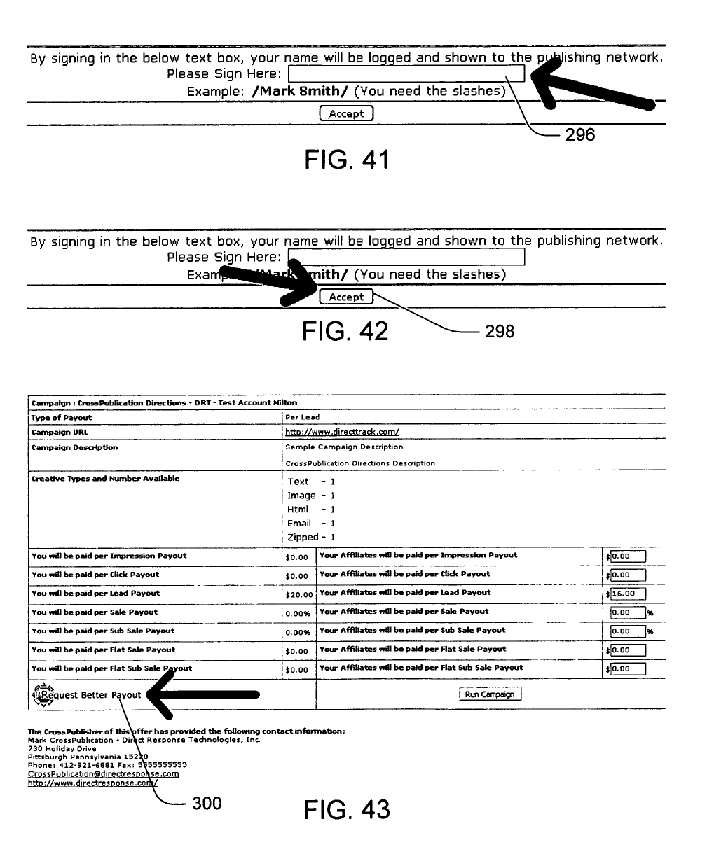

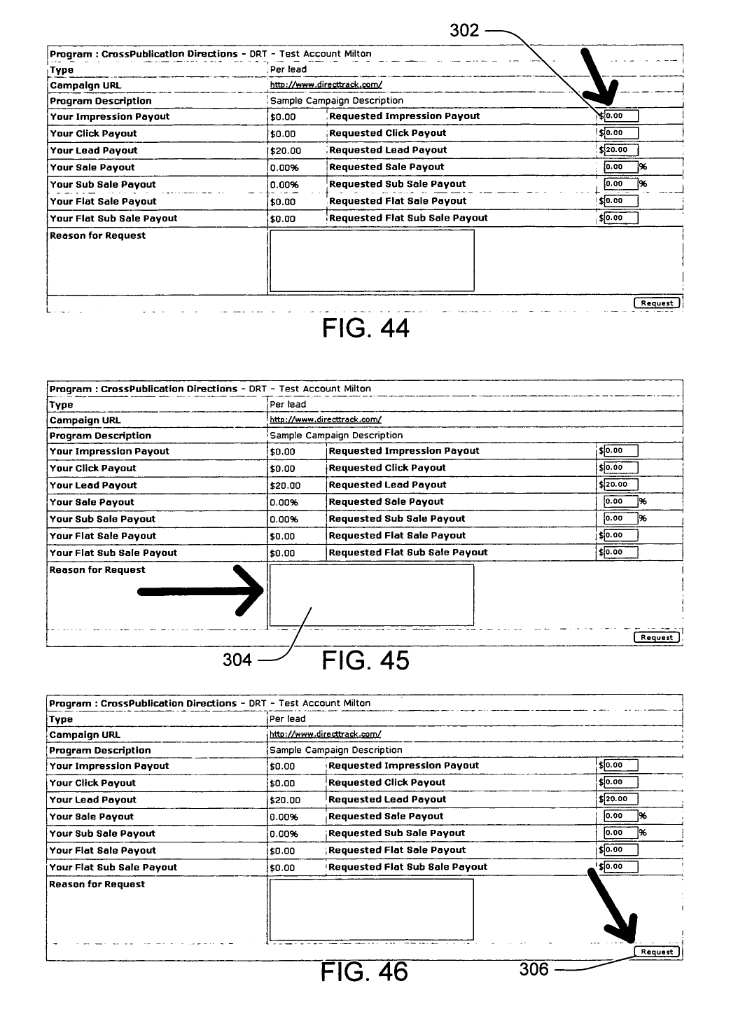

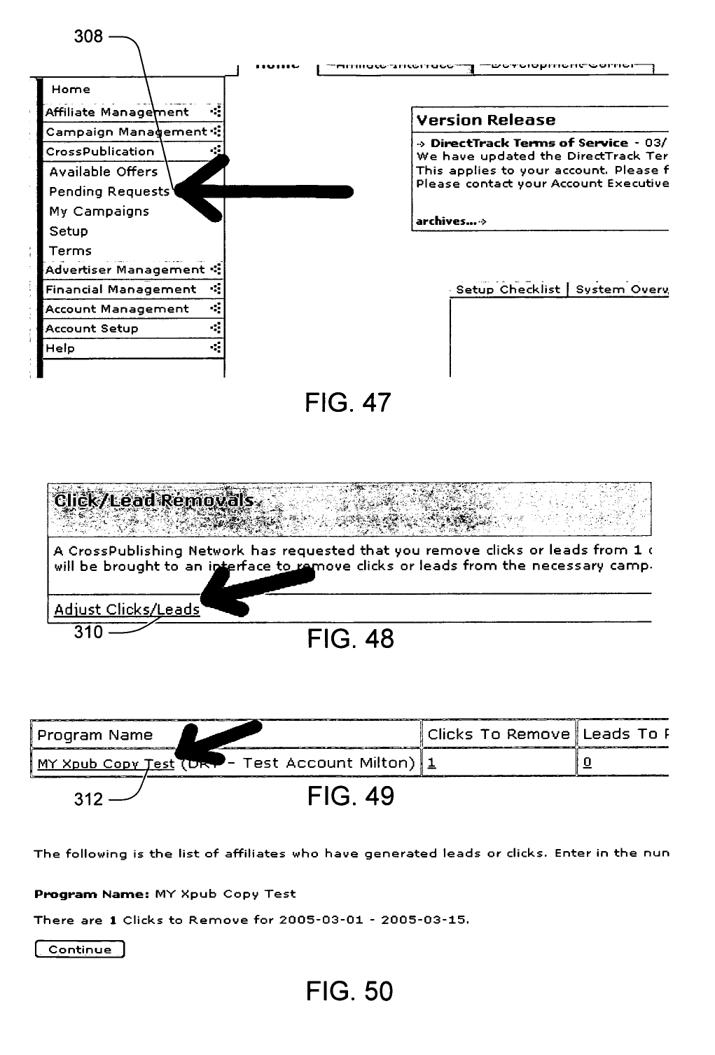

Referring now to FIG. 3, a Re-CrossPublication life cycle 180, which is similar to the CrossPublication life cycle 140, is shown. A previously CrossPublished campaign is offered 182 to another network by the Child and this client will be the Parent. Campaigns can be offered out to all networks or specific networks. Another network is given a choice 184 to run the campaign. If they choose not to run the campaign the process ends 186. If they choose to run the offer the process continues and they will be known as the Grandchild. Subsequently, the Child is given a choice 188 to approve the Grandchild to run the campaign. If the Child chooses to deny the Grandchild the process ends 190. If the Child chooses to approve the Grandchild to run the campaign the process continues. The network affiliate system copies 192 the appropriate information from the Child to the Grandchild. The Grandchild is then given a choice 194 to activate the offer. If the Grandchild chooses not to run the campaign the process ends 196. If the Grandchild chooses to run the campaign the process continues. A click is generated 198 by the Grandchild's Publisher. The affiliate network system tracks the Publisher's click 200 in the Grandchild and redirects the user to the Child. In addition, the affiliate network system tracks the Grandchild's click in the Child 202 and redirects the user to the Parent. Also, the affiliate network system tracks the Child's click in the Parent 204 and redirects the user to the Advertiser's site. The user completes the action to generate a lead/sale 206. If the action is not completed, the process ends 208. If the action is completed and the pixel is displayed, the lead/sale is tracked 210 in the Parent Network for the Child Network's account. Preferably, the Child's publisher information is stored in the optional information of the lead/sale details. The lead/sale information is copied 212 from the Parent to the Child. In addition, the optional information is read from the lead/sale to credit the appropriate publisher in the Child. The lead/sale information is copied 214 from the Child to the Grandchild. In addition, the optional information is read from the lead/sale to credit the appropriate publisher in the Grandchild. The CrossPublication cycle 180 is complete 216.

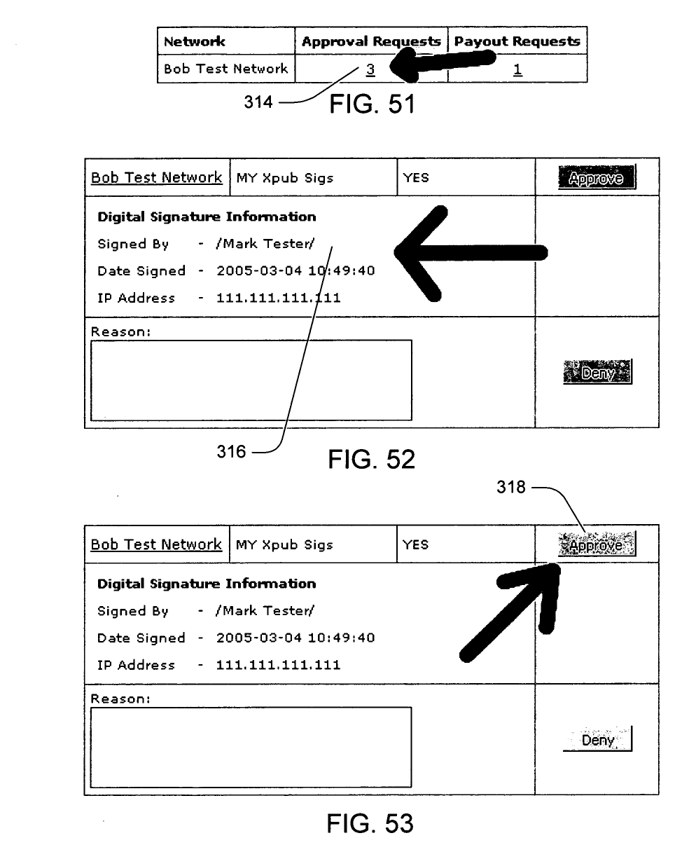

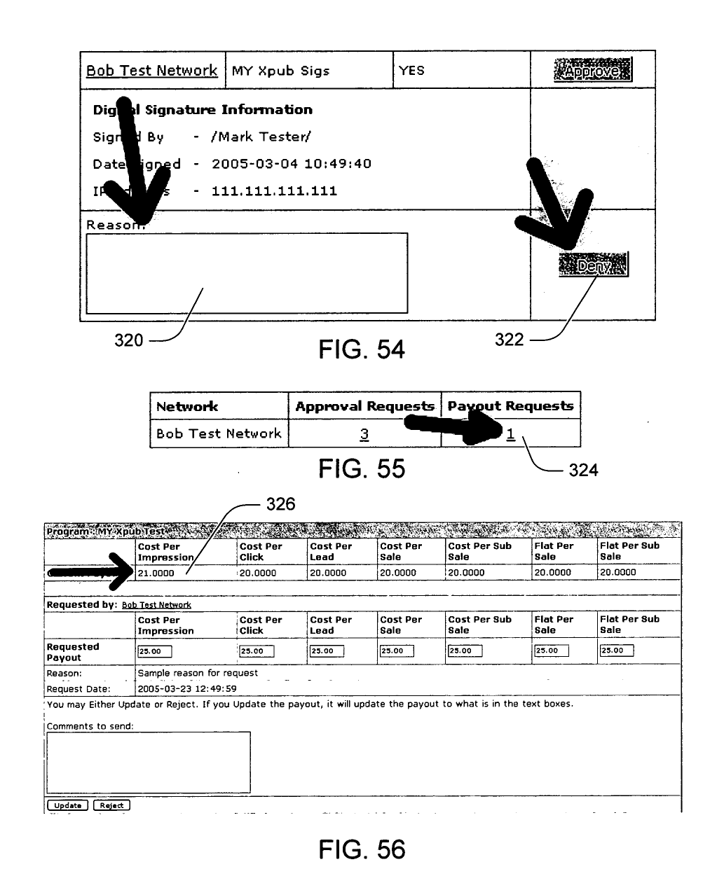

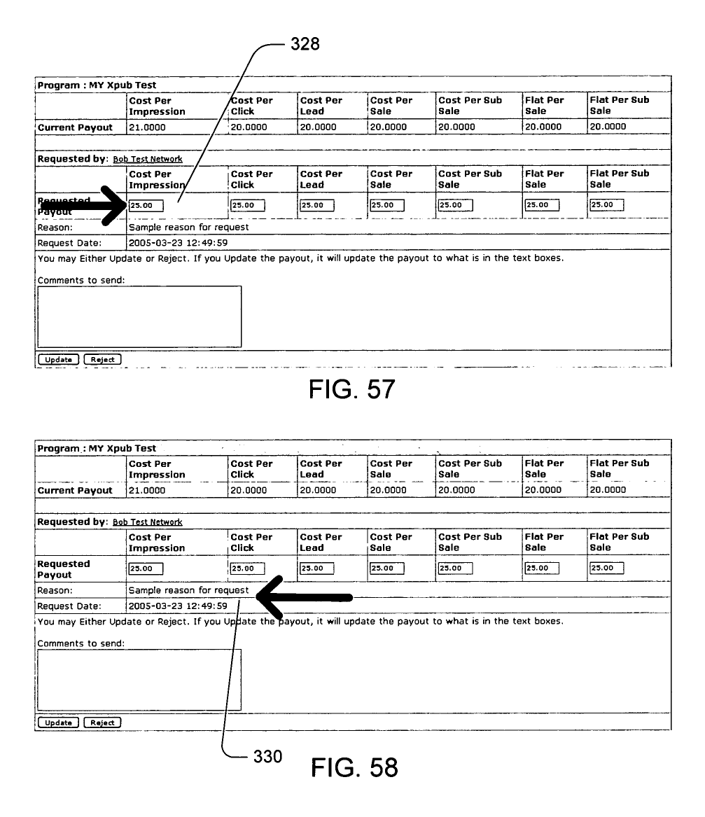

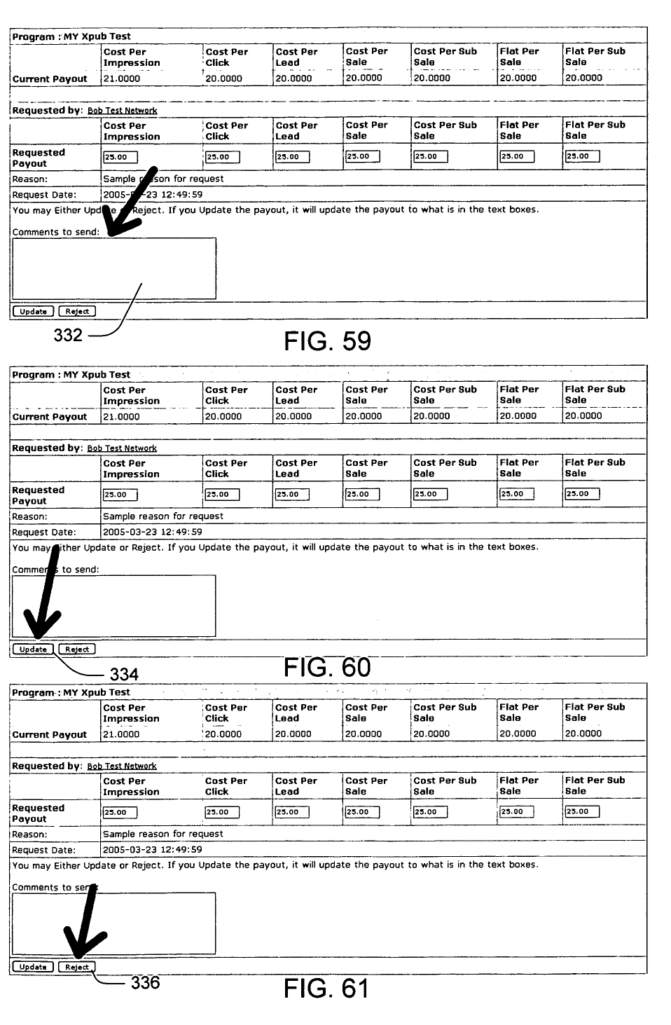

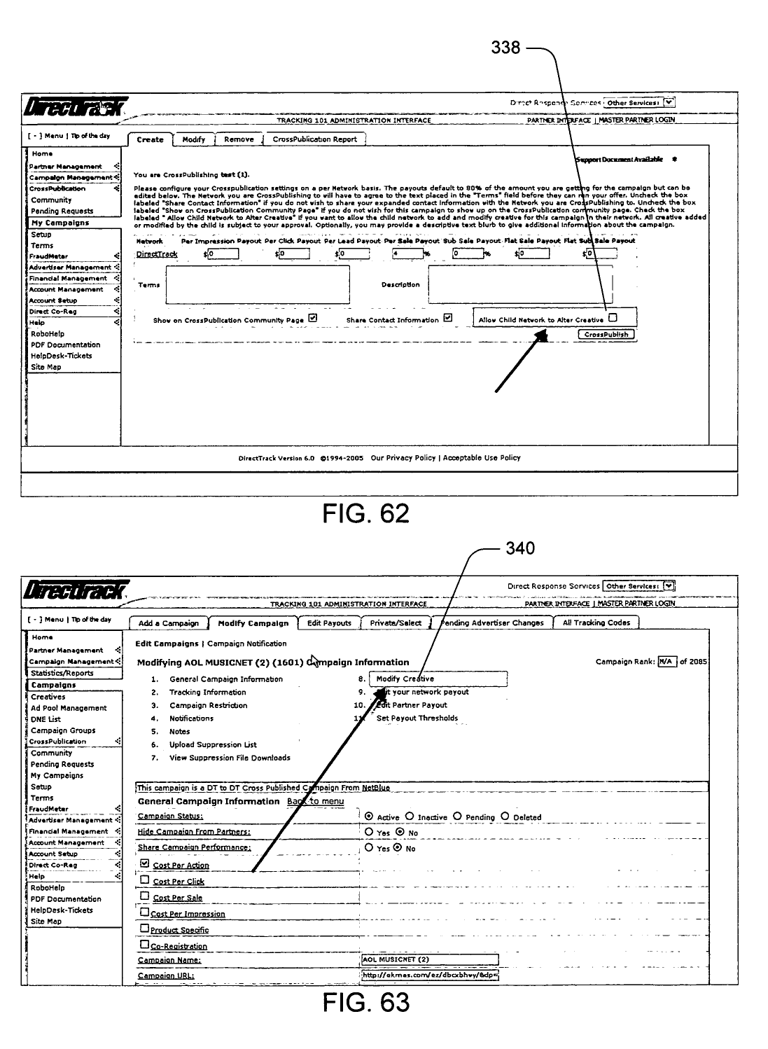

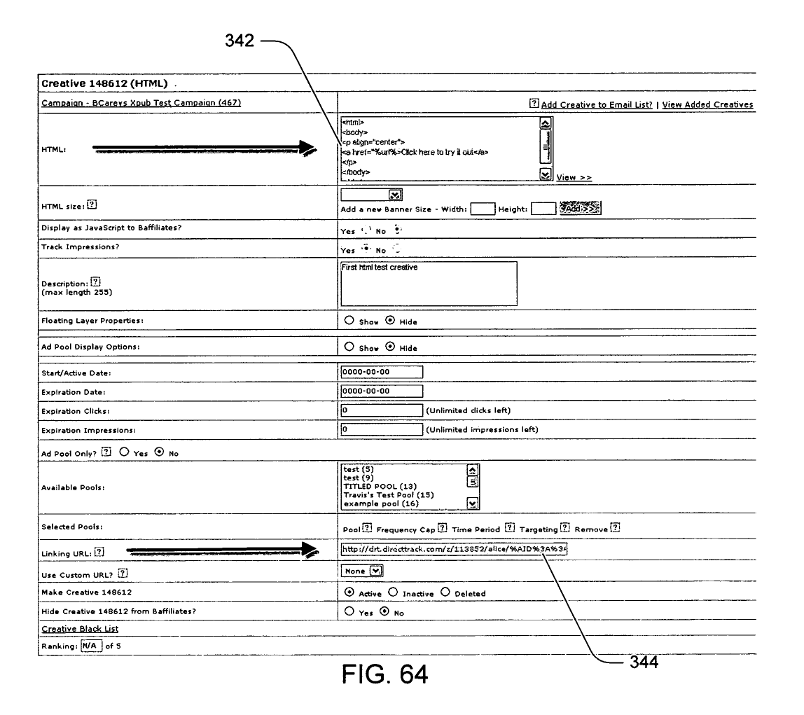

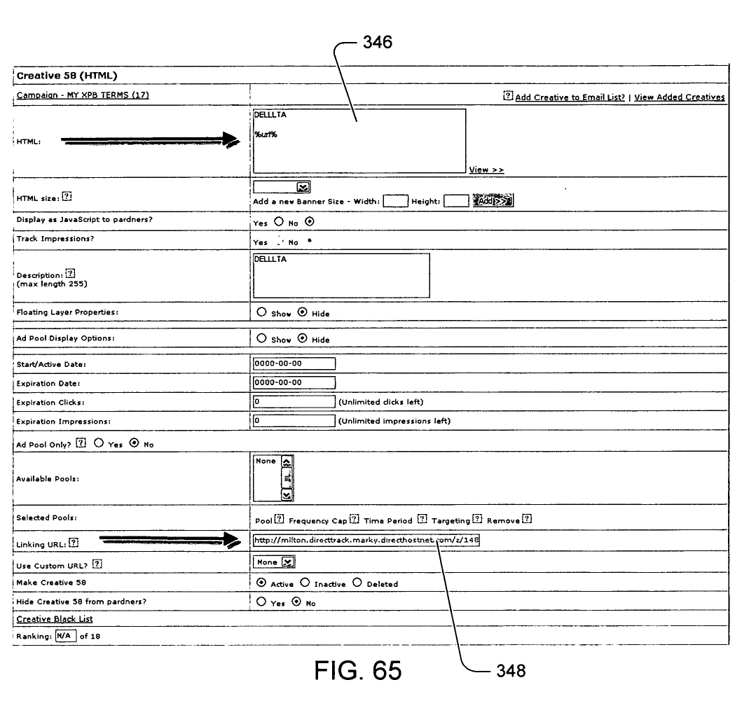

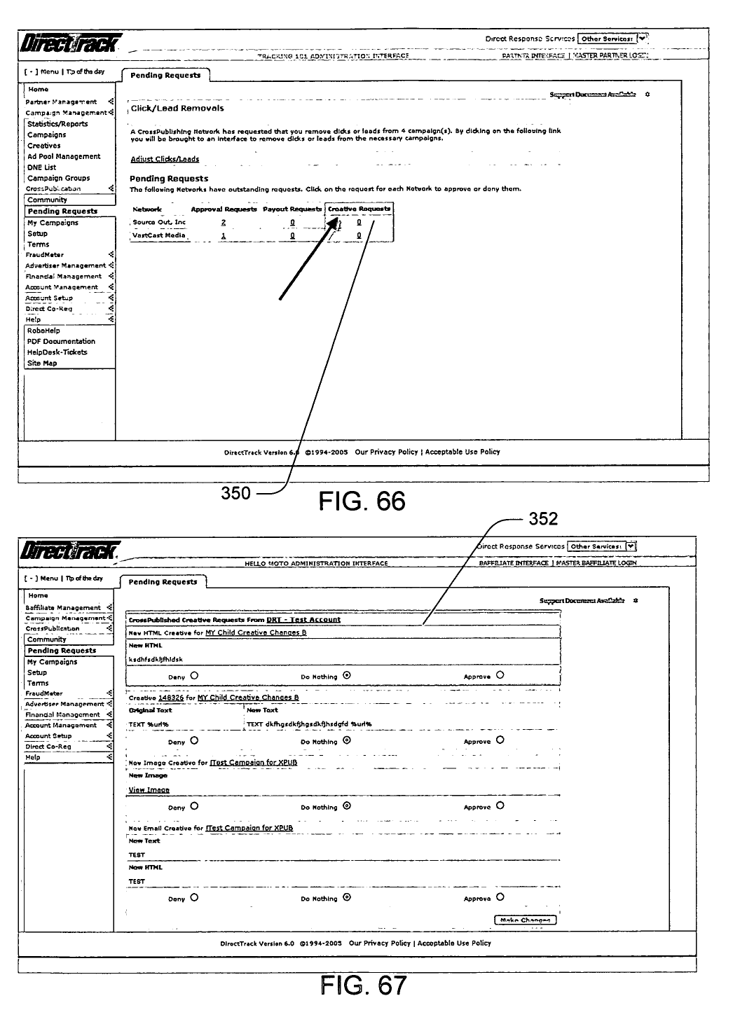

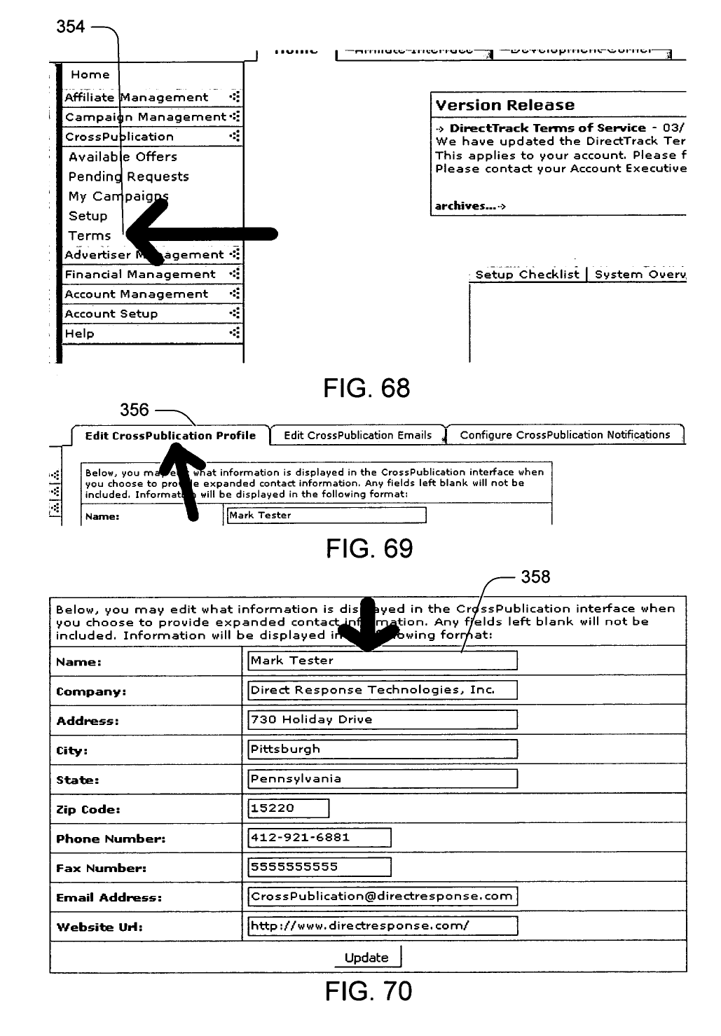

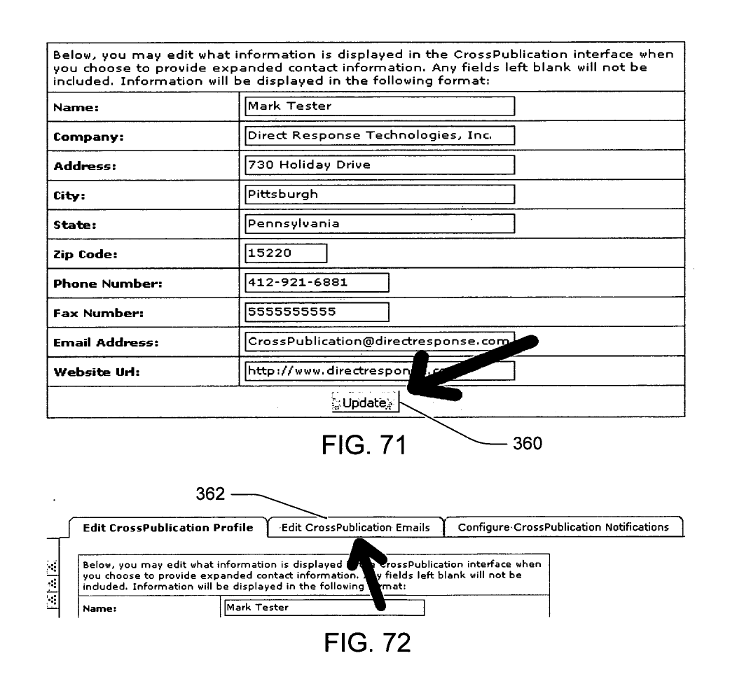

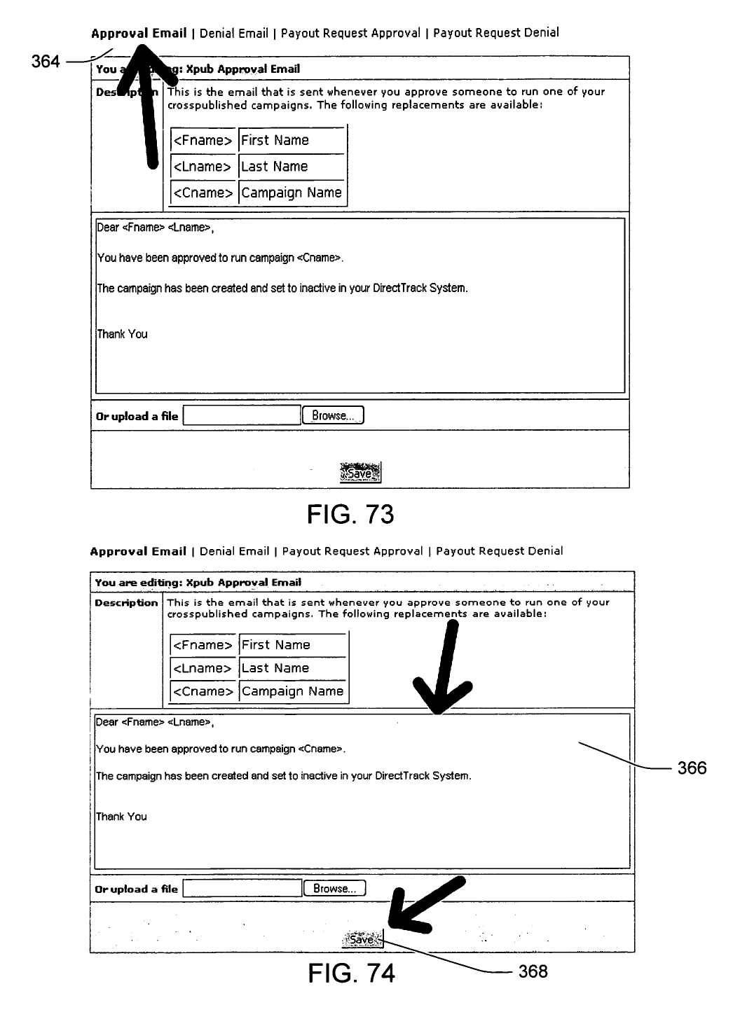

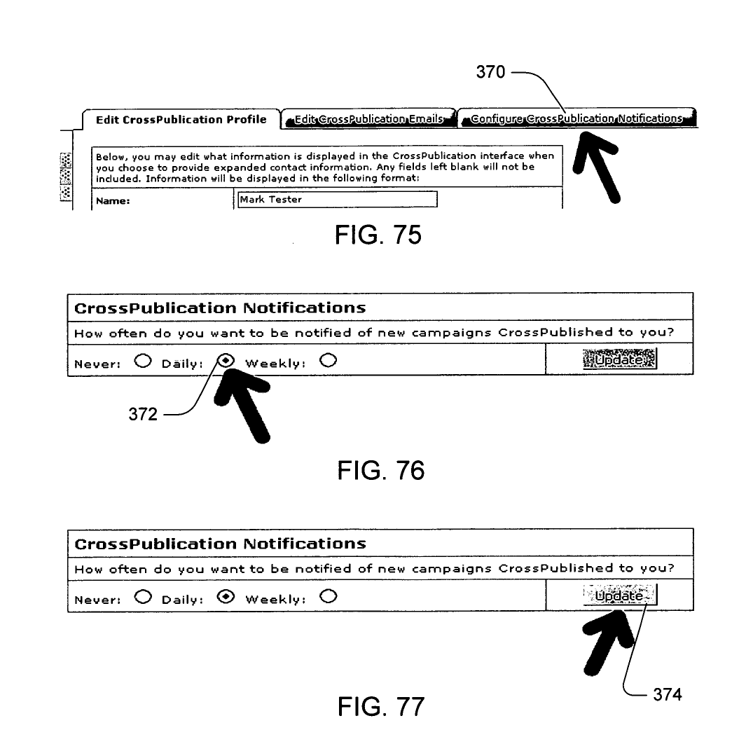

The following series of FIGS. 4 through 77 depict the user interface (e.g., screen shot 218 in FIG. 4) for a preferred embodiment CrossPublication tool that allows our clients to easily publish offers to one another. In this tool, the copying a CrossPublished offer from one client to another occurs automatically upon the approval of the publishing client. Lead and sale tracking is also automated to ensure that there are no tracking discrepancies.

### Enabling CrossPublication

To enable CrossPublication, you must log in to your Affiliate network system backend. If you go to the CrossPublication section shown in FIG. 4, only the “Terms” link 220 will be available. Click on it 220 to review the CrossPublication terms. If you are a Network client, you will be presented with the terms on this page as shown in FIG. 5 and can agree to them by digitally signing the page 222. Once this step is complete, you will have access to the CrossPublication section. If you are a Merchant client as shown in FIG. 6, you need to download 224 the “Market Place User Agreement” and then sign and return the agreement to the affiliate network system operator. Once an agreement is received and approved, you will receive an email notifying you that CrossPublication is now enabled for your account.

### Enabling CrossPublication Reception

Network clients can only signup to receive CrossPublished campaigns from other affiliate network system clients. Signing up to receive CrossPublished offers is not necessary in order to CrossPublish offers to other Affiliate network system clients. To opt-in to receive CrossPublished offers, click 226 on “Available Offers” as shown in FIG. 7. Then, from the Merchant Offer tab of FIG. 8 click 2287 on “Please Click Here.” In FIG. 9, check the box labeled “Enable Me” and click on “Update” button 228.

### CrossPublishing Your Offers

To CrossPublish one of your offers, click on “My Campaigns” 232 from the “CrossPublication” header in the menu shown in FIG. 10. From the window shown in FIG. 11, choose the campaign you wish to CrossPublish from the drop down menu and click on “CrossPublish” button 234. As shown in FIG. 12, choose the Networks you want to CrossPublish to by moving them from the “Available Networks” list to the “Chosen Networks” list. You can move the Networks from one list to another by either double-clicking on the Network name or using the buttons 236. When choosing multiple Networks, you can CrossPublish to them all using the same payouts and terms by checking the box 238 beneath the Network selection area as shown in FIG. 13. To continue to the next step, click on “Continue” button 240 as shown in FIG. 14. As shown in FIG. 15, you may skip choosing individual Networks and CrossPublish to all Networks at one time by clicking on the button 242 labeled “CrossPublish to All.”

Next in the payout setup window shown in FIGS. 16 through 20, input the payouts you wish to offer to other Affiliate network system clients into the boxes 244 labeled “Per (type) Payout.” These payouts default to 80% of the payout you are getting for the campaign. You can place any CrossPublication specific terms into the area 246 labeled “Terms.” The Publishee Network will need to agree to these terms in able to be able to run your offer. Text placed in the field 248 labeled “Description” is shown to any potential Publishee Networks and is CrossPublication specific. Leave the box 250 labeled “Share Contact Information” checked if you wish to give your expanded contact information to any potential Child Networks. Click on “CrossPublish” 252 to add your campaign to the affiliate network CrossPublication system.

In Merchant CrossPublication shown in FIGS. 21 through 23, the steps described above are the same except that the affiliate network system operator approves each campaign for CrossPublication. First, go to “My Campaigns” 254 from “CrossPublication.” Then, choose the campaign you wish to CrossPublish from the drop down menu and click on “CrossPublish” button 256. Click on “Request to be CrossPublished” 258 to notify the network operator that you wish to CrossPublish your campaign. Once your request is received to CrossPublish the campaign, you may then go back through the process to CrossPublish the campaign like normal. The only exception is that a Merchant client does not get to choose individual Networks; instead they default to CrossPublishing to all Network Clients. You will only have to request to be CrossPublished once per campaign.

### Modifying a CrossPublication

By modifying a CrossPublication, you are changing how the CrossPublished campaign is displayed to the Affiliate network system Network clients. You are not altering the campaign itself, nor are you changing the campaign in any Child Network that may be running it. As shown in FIG. 24, a user first goes to “My Campaigns” 260 from the “CrossPublication” menu item. Then, by clicking on the “Modify” tab 262 at the top of the page shown in FIG. 25. Subsequently, the CrossPublication you wish to modify is chosen from the drop down menu and you are to click on “Modify” button 264 shown in FIG. 26. The original CrossPublication info you provided will be filled in. Click on “CrossPublish” 266 shown in FIG. 27 to make your changes final.

### Deleting a CrossPublication

Deleting a CrossPublication will only remove it from the CrossPublication section of an affiliate network system. Choosing to delete a campaign from CrossPublication will not change the original campaign in your system, change the CrossPublished campaign in any Child Network, or make tracking cease to function for any Child Networks. To delete a CrossPublication as shown in FIGS. 28 through 31, go to “My Campaigns” 268 in the “CrossPublication” section.

Click on the “Delete” tab 270 at the top of the page. Choose the CrossPublication that you want to delete from the drop down menu and click on “Delete” button 272. Click on “OK” 274 in the confirmation pop-up to finally delete your CrossPublication.

Updating an Offer that has been CrossPublished

Since CrossPublication is integrated into the affiliate network system, you can change the details of a CrossPublished campaign in the Child Network by changing the campaign settings in your copy of the affiliate network.

When you change information about a campaign, only the “Campaign Status, ” “Approved Subject Lines,” and “End Date” fields can be changed in the Child Network from the Parent Network. If the “Campaign Status” of a campaign is set to an inactive status (“Inactive” or “Deleted”) , then the corresponding campaign is set to “Inactive” in the Child Network. The Child Network is emailed whenever the Parent Network sets the campaign to an inactive status. The Parent Network cannot turn the campaign back on in the Child Network. In the case of a change to the “End Date” field, the campaign in the Child Network is updated and the owner of the Child Network is notified. When the “Approved Subject Lines” are updated in the Parent Network, each Child Network is simply updated.

Updates to the “Suppression List” or “Campaign Terms” of a CrossPublished campaign will automatically carry through to the Child Networks with no notification made to the Child Network. If the Parent Network is using a list from the same affiliate network operator to manage their suppression list, the affiliates of each Child Network will have access to the suppression list and unsubscribe links.

Adjusting the affiliate payout for a Child Network from the Parent Network for a CrossPublished campaign will automatically trigger a notification to the Child Network, informing them that their payout for the CrossPublished campaign has changed. This will not make any changes to any of the payouts in the Child Network.

### Adding and Updating Creative for a CrossPublished Campaign

Creative is added or updated from the affiliate network system interface in the same way as is done for a CrossPublished campaign. Any creative added is automatically added to the Child Network, and any creative changed is updated in the Child Network.

### Removing Clicks, Leads, or Sales

For a CrossPublished campaign, clicks and leads are removed from the “Remove Clicks/Leads” tab in the Fraud Management section of the affiliate network system. Sales are removed from “Manage Sales” in the “Modify Statistics” tab in the “Statistics/Reports” section of the affiliate network system.

When a sale is removed, the corresponding sale in the Child Network is automatically removed and the Child Network is notified. When a click or lead is removed, the Child Network is notified that they need to remove the appropriate number of clicks and leads from their affiliates.

### Importing Leads

To import leads for a CrossPublished campaign, be sure to use the lead import functionality found by going to “Statistics/Reports” from the main menu, clicking on the “Import Campaign Stats” tab, and then choosing “Import Leads With Optional Info” from the sub menu. It is required that this report is used or else the leads will not sync properly between Publisher and Publishee. When importing, import one lead per comma separated value (CSV) line. Use the affiliate code of the Child Network for the “Affiliate Code” field. You can import for an arbitrary date in the past, but it is not wise to import leads for dates prior to the last run of your payment scripts. The cookie_id from the tracked lead should be used in the “cookie_id/optinfo” field. Once added, these leads will be picked up by the CrossPublication sync process and added to the correct affiliates in the Child Network.

### CrossPublishing Offers from Other Affiliate Network System Clients

To view the offers CrossPublished to you by other affiliate network system clients, click on “Available Offers” in the CrossPublication menu 276 as shown in FIG. 32. You can then choose to browse offers available from the affiliate network system Merchant clients 278 and Network clients 280 separately by choosing the appropriate tab in the window shown in FIG. 33.

### Running a CrossPublished Campaign

You can browse the campaigns shown in FIG. 34 that an affiliate network system client is making available by clicking on the company name 282 of the affiliate network system client CrossPublishing the offer. Choose the CrossPublished campaign 284 as shown in FIG. 35 you are interested in running. In FIG. 36, the first four rows give some basic information about the campaign including the description of the campaign, the creative types 286 and number available. In FIG. 37, the payouts in the first column 288 are the payouts offered to you by the Publisher of this offer. In FIG. 38, the payouts in the second column 290 are what your affiliates will be paid if you run this campaign. If the Publisher of this campaign chooses to provide expanded contact information, it will be displayed under the campaign details 292 of FIG. 39. If you are happy with the details of the campaign, click on “Run Campaign” button 294 shown in FIG. 40.

Next, you will be given a window as shown in FIG. 41 with the terms for this campaign. Once you have reviewed the terms, you need to digitally sign them by entering your name in field 296 labeled “Please Sign Here.” Please note that you need to place slashes on either side of your name for your signature to be valid.

Finally, you need to click accept 298 as shown in FIG. 42 and the publishing Network will be notified that you want to run their campaign.

### Requesting a Better CrossPublishing Payout

When reviewing the CrossPublished campaign's payouts, and you want to request a better payout for the campaign, click on “Request Better Payout” button 300 as shown in FIG. 43. The request page is similar in layout to the CrossPublished campaign description page. The payouts in the second column 302 of FIG. 44 are the payouts you are requesting for this campaign. Once you have inputted your desired payouts, you may place a reason for your request in the field 304 labeled “Reason for Request” of FIG. 45. Finally, click on “Request” 306 in FIG. 46 to send your payout request to the publisher of this offer.

### Pending Requests

The affiliate network system CrossPublication manages three types of requests for you. Lead/click removal requests are requests from the publisher of a CrossPublished offer that you are running to remove either clicks or leads from a CrossPublished campaign. Campaign approval requests are requests from other affiliate network system clients who want to run your offer. Payout requests are requests for better payouts for the CrossPublished offers you have made available. You can browse all of these requests by clicking on “Pending Requests” 308 in the “CrossPublication” section of the affiliate network system menu shown in FIG. 47.

### Leads/Clicks Removals

If you have to remove clicks or leads from a CrossPublished campaign, a prompt as shown in FIGS. 48 through 50 will appear on the “Pending Requests” page.

Click on “Adjust Clicks/Leads” 310 to remove clicks or leads from the necessary campaigns. The next page will have a breakdown of all of the CrossPublished campaigns that need clicks or leads adjusted. Click on the campaign name of the campaign 312 that you want to adjust. Once you have chosen which affiliates to remove clicks or leads from, click on “Continue” in FIG. 50 to remove the clicks or leads from the campaign.

### Campaign Approval Requests

If you have pending campaign approval requests, they will appear on the “Pending Requests” page as shown in FIG. 51. The campaign approval requests will be broken down by network. Click on the number 314 of approval requests to view details about the campaign approval request. This page shown in FIG. 52 lists each campaign approval request individually. Each request includes the digital signature information 316 provided when the Publishee network agreed to your terms. To approve the Child Network's request to run your campaign, click on the “Approve” button 318 shown in FIG. 53. This will notify the child network that they have been approved and the campaign will be copied into their network. To deny a request to run your campaign, put a denial reason in the field 320 labeled “Reason” and click on the “Deny” button 322 as shown in FIG. 54.

### Payout Requests

If you have pending payout modification requests, they will appear on the “Pending Requests” page as shown in FIG. 55. The payout modification requests will be broken down by network. Click on the number 324 of payout modification requests to view details about the payout modification request. The pending payout modification requests will be broken down by campaign. As shown in FIG. 56, the row 326 contains the current payouts for the CrossPublication. The second row 328 of FIG. 57 contains the Publishee's requested payouts. You may further adjust the payouts if you so desire. The reason for the request 330 will be shown in FIG. 58 beneath the Child Network's requested payouts as well as the date of the request. Text placed in the “Comments to Send” field 332 of FIG. 59 will be included in the email sent to the Publishee whenever you approve or deny their request. To approve the request, click on the “Update” button 334 of FIG. 60. This will update the payouts and send the Publishee an email notifying them that their payout request has been approved. To deny the request, click on the “Reject” button 336 of FIG. 61. This will email the Publishee to inform them that their payout request has been rejected.

### Modifying Creatives

Another feature of the affiliate network system as shown in FIGS. 62 through 67 is to allow Child networks to modify a creative (i.e., an ad, banner, image, text, etc.) of a campaign. By selecting the check box 338 shown in FIG. 62, a Parent may allow a Child to change a creative from the Parent. Once this is selected, a Child is given the option to modify 340 the creative as shown in FIG. 63. When a Child network is not allowed to alter a creative, the creative will be locked or grayed out 342 as shown in FIG. 64. The linking URL may also be locked 344. In contrast, FIG. 65 shows that a creative may be unlocked or ready for editing 346, even though the linking URL is still locked 348. As shown in FIG. 66, once the Child network changes the Creative, it is in the Parents Pending Request 350 and is not changed until approved. The same process applies to new creatives added by the child. FIG. 67 shows that a Parent is presented with several options 352 when reviewing the modification request from a Child, including: Deny, Do Nothing, and Approve.

### CrossPublication Setup

You can access the CrossPublication setup by clicking on “Setup” 354 in the “CrossPublication” section of the affiliate network system menu shown in FIG. 68.

### CrossPublication Profile

To edit your CrossPublication Profile, click on the “Edit CrossPublication Profile” tab 356 of the window shown in FIG. 69. The contact information placed into the text boxes 358 will be displayed as shown in FIG. 70 alongside your CrossPublished offers if you choose to provide expanded contact information.

Any fields left blank will not be included. Click on “Update” 360 to save your contact information as shown in FIG. 71.

### CrossPublication Emails

To edit the contents of the CrossPublication emails that the affiliate network system sends out on your behalf, click on the “Edit CrossPublication Emails” tab 362 of FIG. 72. Click on the email 364 of FIG. 73 you want to customize. Place your custom email content 366 into the text area and then click on “Save” 368 to finish as shown in FIG. 74.

### CrossPublication Notifications

For the affiliate network system Network clients only, to specify how often you receive notifications of newly CrossPublished campaigns, click on the “Configure CrossPublication Notifications” tab 370 of FIG. 75. Choose how often 372 you want to be notified of new campaigns CrossPublished to you as shown in FIG. 76. In FIG. 77 click on “Update” 374 to save your change.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

is claimed is:

1. A network cross publication system for use in affiliate network marketing system, the network cross publication system comprising:
a particular campaign comprising at least one creative and associated payout information, the creative comprising a piece of promotional material used to advertise a product;
a parent affiliate network originating the particular campaign, the parent affiliate network being operated by a system operator that tracks actions by an end user on an advertiser's website; and
a cross publisher operatively configured to publish the particular campaign from the parent affiliate network to a child affiliate network such that the child affiliate network can run a campaign derived from the particular campaign.

2. The cross publication system of claim 1 wherein the actions by an end user comprise an action selected from a group consisting of: a purchase of the goods or services that the advertiser is selling, providing some information to the advertiser, or clicking on a button on the advertiser's web page.

3. The cross publication system of claim 1 further comprising a campaign modifier module operatively configured to permit a member of the child affiliate network to modify the particular campaign to form the campaign derived from the particular campaign where modifying comprises one or more of the following: altering creatives, adding creatives, and changing payout information.

4. The cross publication system of claim 1 further comprising a campaign approver module operatively configured to permit a member of the parent affiliate network to approve a child network to run the campaign derived from the particular campaign.

5. A method for network cross publication in an affiliate network marketing system, comprising steps of:
selecting a particular campaign comprising at least one creative and associated payout information, the creative comprising a piece of promotional material used to advertise a product; and
cross publishing the particular campaign from a parent affiliate network to a child affiliate network such that the child affiliate network can run a campaign derived from the particular campaign and pass tracking information from the child affiliate network to the parent affiliate network.

6. The method of claim 5 further comprising a step of creating the particular creative by a member of the parent affiliate network.

7. The method of claim 5 further comprising a step of modifying the particular campaign by a member of the child affiliate network to form the campaign derived from the particular campaign where modifying comprises one or more of the following: altering creatives, adding creatives, and changing payout information.

8. The method of claim 5 further comprising a step of approving by the parent affiliate network the campaign derived from the particular campaign prior to permitting the campaign derived from the particular campaign to be run by the child network.

9. The method of claim 5 further comprising a step of cross publishing the particular campaign from a child affiliate network to a grandchild affiliate network such that the grandchild affiliate network can run a campaign derived from the particular campaign and pass tracking information from the grandchild affiliate network to the parent affiliate network.

10. The method of claim 5 further comprising a step of requesting modified payout information from the parent affiliate network for the campaign derived from the particular campaign.

11. The method of claim 5 further comprising a step of applying for approval from the parent affiliate network to run the campaign derived from the particular campaign in the child affiliate network.

12. The method of claim 5 further comprising a step of running in the child affiliate network the campaign derived from the particular campaign.

14. A method for utilizing network cross publication in an affiliate network marketing system, comprising steps of:
selecting a particular campaign comprising at least one creative and associated payout information, the creative comprising a piece of promotional material used to advertise a product, the particular campaign being cross published from a parent affiliate network to a child affiliate network; and
running in the child affiliate network a campaign derived from the particular campaign.

14. The method of claim 13 further comprising a step of passing tracking information from the child affiliate network to the parent affiliate network about the campaign derived from the particular campaign.

15. The method of claim 14 wherein the tracking information comprises at least one action by an end user on an advertiser's website, the at least one action being selected from a group consisting of: a purchase of the goods or services that the advertiser is selling, providing some information to the advertiser, or clicking on a button on the advertiser's web page.

16. The method of claim 13 further comprising a step of modifying the particular campaign by a member of the child affiliate network to form the campaign derived from the particular campaign where modifying comprises one or more of the following: altering creatives, adding creatives, and changing payout information.

17. The method of claim 13 further comprising a step of approving by the parent affiliate network the campaign derived from the particular campaign prior to permitting the campaign derived from the particular campaign to be run by the child network.

18. The method of claim 13 further comprising a step of cross publishing the particular campaign from a child affiliate network to a grandchild affiliate network such that the grandchild affiliate network can run a campaign derived from the particular campaign and pass tracking information from the grandchild affiliate network to the parent affiliate network.

19. The method of claim 13 further comprising a step of requesting modified payout information from the parent affiliate network for the campaign derived from the particular campaign.

20. The method of claim 13 further comprising prior to the running step a step of applying for approval from the parent affiliate network to run the campaign derived from the particular campaign in the child affiliate network.
